(19) United States
(12) Patent Application Publication
(10) Pub. No.: US 2004/0149840 A1
(43) Pub. Date: Aug. 5, 2004

(54) Injector comprising a piezo actuator

(76) Inventors: Werner Remmels, Immenstaad (DE); Arne Schneemann, Meckenbeuren (DE); Bernd Danckert, Meckenbeuren (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/481,471

(22) PCT Filed: Jun. 18, 2002
(86) PCT No.: PCT/EP02/06678

(30) Foreign Application Priority Data
Jun. 20, 2001 (DE) 101 29 375.5

(51) Int. Cl. B05B 1/08; B05B 3/04

(52) U.S. Cl. 239/584; 239/102.2

(57) ABSTRACT

For an internal combustion engine, an injector (1) with piezo actuator (2) is provided. In addition, there is provided a means for recognition for recognizing the lying position or opening of the piezo actuator (2) on a control valve. The means for recognition includes a piezo element (3).

The invention relates to an injector for an injection system of an internal combustion engine, which exhibits a piezo actuator, a control valve, an injector needle and a means for recognition for recognizing the lying position or the opening of the piezo actuator on the control valve.

In the use of an injector with a piezo actuator, in practice, there occurs the problem that the length of the piezo actuator changes depending on the temperature. This temperature-dependent change in the length of the piezo actuator causes an irregular closing and opening behavior in the injector and results in a non-reproducible injection point of time and injection course.

A solution for the problem described is known from DE 199 29 589 A1. The injector with piezo actuator presented therein additionally has a means for recognition. This consists of an electrical contract and a compensator circuit. The electrical contact occurs through the contact surfaces of the piezo actuator and the control valve. When the piezo actuator is lying on the control valve, a closed circuit thereby occurs from the piezo actuator/control valve to the compensator circuit. What is problematic in this solution is the insulation of the piezo actuator inside the injector and also the changing transition resistance on account of deposits.

The object of the invention is to determine the point of time of opening and/or closing in an injector with a piezo actuator with greater certainty.

The object is attained through the features of claim 1. The arrangements for this are presented in the subclaims.

The invention provides that the means for recognition include a piezo element. Advantageously, this is integrated in the piezo actuator. One element of the piezo actuator is thus used for measuring power. In the initial state, a slot is provided between the piezo actuator and the control valve. Changes in the length of the piezo actuator on account of temperature thus do not necessarily lead to an opening of the injector. The lying position/opening of the piezo actuator is recognized in that a measuring voltage located on the piezo element exceeds a limiting value. The measuring voltage that is determined is then set as [the] determinant [value] for the subsequent controlling of the injector. Alternatively it is provided that one weighted measuring voltage is determined from among a preset number of determined measuring voltages and this [voltage] is set as [the] determinant [value] for the subsequent controlling of the injector. The invention offers the advantage of a corresponding longer service life of the injector. Through the precise, reproducible recognition of the opening behavior of the injector, it is possible to regulate the injection for each cylinder individually. As a consequent reaction, the momentary contributions and the peak pressure of the individual cylinders can be adjusted to one another.

In the drawings, one embodiment is represented.

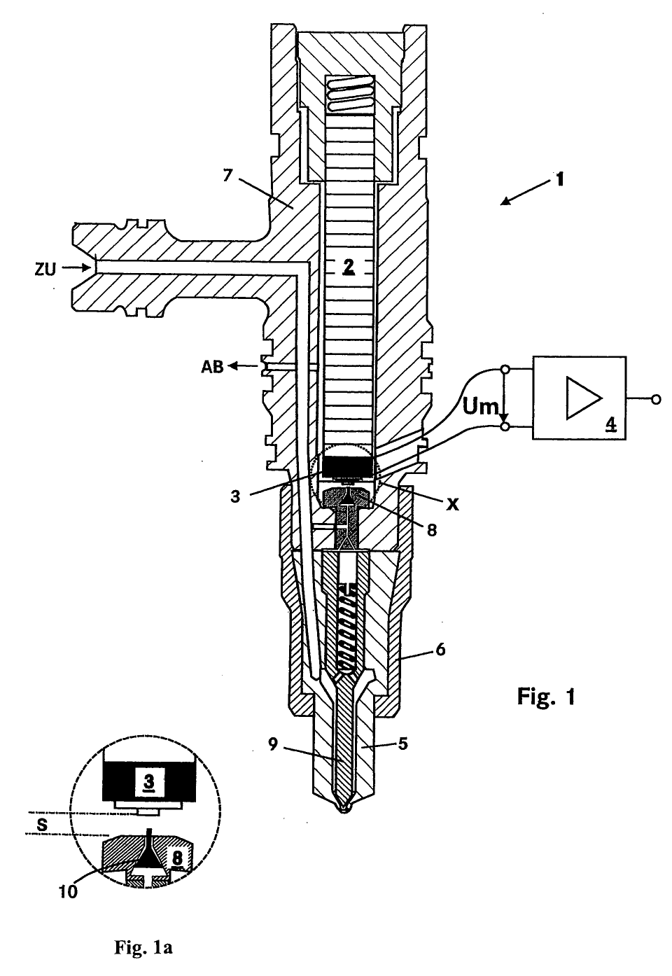

FIG. 1 shows: a cut-away view of the injector

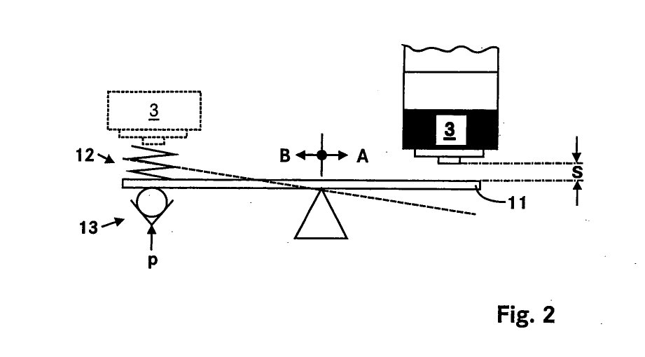

FIG. 2 shows: a skeleton diagram for the mechanical transmission.

FIG. 1 shows a cut-away view of an injector. In the description that follows, it is presumed that the overall functioning of the injector is already known. Injector 1 consists of basic body 7, nozzle 5 and swivel nut 6. Inside nozzle 5 there is located injector needle 9. Inside basic body 7 there is located piezo actuator 2 and control valve 8 with valve body 10. By way of the electrical controlling of the piezo actuator, the state of injector needle, and thereby the point in time of the injection and the amount of the injection, is determined. One piezo element 3 of piezo actuator 2 is used in this process for measuring power. In place of a piezo actuator, of course, a mechanically or an electro-magnetically activated activation device can also be used. A measuring voltage Um of piezo element 3 is evaluated by an electronic control device (ECD) 4. In the initial state, there exists between control valve 8 and piezo element 3 a slot s; for this, see View x. By way of this slot s, changes in length of piezo actuator 2 are compensated. If piezo element 3 comes to lie against control valve 8, the level of measuring voltage Um changes. If the measuring voltage Um exceeds a limit value, this is recognized by electronic control device 4. For the subsequent controlling of the injector, this measuring voltage is then set as [the] determinant [value]. As an alternative, it is provided that a weighted measuring voltage is determined from a preset number of determined measuring voltages. This can take place, for example, through arithmetic formation of a mean value. The weighted measuring voltage is then used as [the] determinant [value] for the subsequent operation of the injector.

FIG. 2 shows a skeleton diagram for a mechanical transmission in injector 1. The mechanical transmission is represented, by way of example, as lever 11 with segments A and B. When piezo actuator 2 is activated, valve 13 is opened against the force of a closing device 12. On valve 13, the pressure level p of the fuel is set. In FIG. 2, lever 11 is represented in the opened position. Upon the deactivation of piazo actuator 2, valve 13 is again closed by way of closing device 12. The use of a mechanical transmission offers the advantage that the piezo actuator can be designed to be shorter. By way of closing device 12, the injector is securely closed even in the event of the failure of the electronic control.

The invention offers the advantage that it is easy to design. Because of the determination of the lying position of the piezo actuator that frees it from wear and tear, a correspondingly longer service life of the injector is attained. Through this, it is possible to realize an adjustment of the injection to each individual cylinder.

### List of Reference Terms

1 Injector

2 Piezo Actuator

3 Piezo Element

4 Electronic Control Device (ECD)

5 Nozzle

6 Swivel Nut

7 Basic Body

8 Control Valve

9 Injection Needle

10 Valve Body

11 Closing Device

13 Valve

1. Injector for an injection system for an internal combustion engine, which exhibits a piezo actuator, a control valve, an injection needle and a means for recognition for recognizing the lying position or opening of the piezo actuator on the control valve, characterized in that the means for recognition includes a piezo element (3).

2. Injector (1) according to claim 1, characterized in that the piezo element (3) is integrated in piezo element (2).

3. Injector (1) according to claim 1 or 2, characterized in that the lying position/opening of piezo actuator (2) is recognized, if a measuring voltage (Um) on piezo element (3) exceeds a limit value (GW) (Um>GW).

4. Injector (1) according to claim 3, characterized in that the measuring voltage (Um) that is determined is set as [the] determinant [value] for the subsequent controlling of injector (1).

5. Injector (1) according to claim 3, characterized in that a weighted measuring value (Um(MW)) is determined from among a present number (i) of determined measuring voltages (Um(i)0 and is set as [the] determinant [value] for the subsequent controlling of injector (1).

6. Injector (1) according to any one of the foregoing claims, characterized in that in injector (1), a mechanical transmission is located, by means of which an active lift of piezo actuator (2) is transmitted to closing device (12).
